(19) United States
(12) Patent Application Publication
(10) Pub. No.: US 2018/0163776 A1
(43) Pub. Date: Jun. 14, 2018

(54) ROLLING BEARING ARRANGEMENT

(71) Applicant: Schaeffler Technologies AG & Co. KG, Herzogenaurach (DE)

(72) Inventor: Thomas Heilmann, Poxdorf (DE)

(73) Assignee: Schaeffler Technologies AG & Co. KG, Herzogenaurach (DE)

(21) Appl. No.: 15/575,485

(22) PCT Filed: May 23, 2016
(86) PCT No.: PCT/DE2016/200246

§ 371 Date: Nov. 20, 2017

(30) Foreign Application Priority Data
May 26, 2015 (DE) 10 2015 209 597.5

(51) Int. Cl. F16C 19/18; F16C 25/06; F16C 33/58; F16C 27/04

(52) U.S. Cl. CPC F16C 19/184; F16C 27/04; F16C 33/58; F16C 25/06

(57) ABSTRACT

Rolling bearing arrangements with adjustable bearing play are disclosed. In one example, a rolling bearing arrangement may include a two-row rolling bearing comprising two bearing rings. An adjusting ring of adjustable diameter and having a variable width in a radial direction may be arranged between the bearing rings. The adjusting ring may be of a split design and include a bolt that passes through an aperture in one end of the adjusting ring and is screwed into a threaded hole in the other end of the adjusting ring.

### CROSS-REFERENCE TO RELATED APPLICATIONS

This application is the U.S. National Phase of PCT Appln. No. PCT/DE2016/200246 filed May 23, 2016, which claims priority to DE 102015209597.5 filed May 26, 2015, the entire disclosures of which are incorporated by reference herein.

### TECHNICAL FIELD

The disclosure relates to a rolling bearing arrangement having a two-row rolling bearing comprising two bearing rings.

### BACKGROUND

Such rolling bearing arrangements are used for various applications. In many cases it is necessary to adjust the bearing play, which is intended to lie within fixed limits. The bearing play can only be adjusted after assembling the rolling bearing arrangement. In practice so-called shims are used for this purpose. These are very thin, laminar interlayers which have a specific thickness. Alternatively, a certain bearing play may be set by grinding operations (adjustment grinding). In certain rolling bearing arrangements the play may also be adjusted by adjusting an axial force, which acts on an inner ring or an outer ring of a rolling bearing.

DE 10 2005 027 082 A1 proposes to adjust the preloading of a rolling bearing arrangement by means of a piezo element. For controlling the piezo element, however, an electrical voltage is required, so that this method of adjusting the bearing play is limited to specific applications.

### SUMMARY

An object of the disclosure is therefore to specify a rolling bearing arrangement which allows easy adjustment of the bearing play by the user.

According to the disclosure this object may be achieved in a rolling bearing arrangement of the aforesaid type in that an adjusting ring of adjustable diameter and having a variable width in a radial direction is arranged between the bearing rings.

The disclosure is based on the finding that an easy and user-friendly adjustment of the bearing play is possible if the rolling bearing arrangement comprises an adjusting ring, the diameter of which is adjustable. Here the adjusting ring is arranged between the bearing rings, which in turn comprise raceways for rolling elements, so that the bearing play can be adjusted and set by adjusting the diameter of the adjusting ring. This eliminates the fitting of shims, which for the most part have to be done step by step and repetitively. There is similarly little need for grinding operations, which in practice take up a considerable amount of time. Instead the bearing play is extremely easy to adjust through an adjustment of the diameter performed on the adjusting ring. Since the adjusting ring touches the bearing rings and has a width varying in a radial direction, it is possible to influence the distance between the two rows of rolling elements in a tangential direction or in an axial direction by adjusting the diameter of the adjusting ring, in order to adjust the bearing play.

In a development of the disclosure the adjusting ring is of split design and comprises a bolt, which passes through an aperture in one end of the adjusting ring and is screwed into a threaded hole in the other end of the adjusting ring. It is therefore merely necessary to design the adjusting ring as a split ring and to provide one end with a threaded hole, into which a bolt is screwed, which is supported on an aperture formed on the other end of the adjusting ring. Equivalent configurations are obviously also feasible, for example one end of the adjusting ring could be provided with an external thread, which is screwed to a sleeve which has an internal thread and which is pushed through the aperture on the other end of the adjusting ring.

In the case of the rolling bearing arrangement according to the disclosure the adjusting ring preferably has a width diminishing radially inwards. The cross section of the adjusting ring therefore diminishes towards the center and increases radially out-wards. The adjusting ring accordingly has one or preferably two opposing axial surfaces which form an angle with the radial direction. The adjusting ring therefore has areas of varying width, the term width here denoting the extent in an axial direction. Since surfaces of the adjusting ring touch both of the axially adjacent bearing rings, the radially inward diminishing width of the adjusting ring means that the desired setting of the bearing play can be undertaken by adjusting the diameter of the adjusting ring. It is therefore extremely easy to adjust the bearing play by moving the bolt of the adjusting ring. In this context the bolt and the threaded hole of the adjusting ring more preferably have a self-locking thread, thereby preventing a spontaneous adjustment.

In the case of the adjusting ring of the rolling bearing arrangement according to the disclosure the ring may have a trapezoidal or triangular cross section. The cross section is more preferably trapezoidal, so that there is sufficient overall space for the threaded hole. Modifications are also feasible, however, in which the threaded hole in the split adjusting ring is arranged externally on the adjusting ring; the same also applies to the aperture on which the bolt is supported. The cross section of the adjusting ring may therefore also be triangular.

In the case of the rolling bearing arrangement according to the disclosure the rolling bearing may be embodied as a radial bearing or as an axial bearing. With both configurations of the rolling bearing a radial adjustment of the adjusting ring serves to influence and to adjust the bearing play in an axial direction. If the rolling bearing is a radial bearing, the bearing rings are preferably embodied as outer rings, which are spaced at an axial distance from one another and between which the adjusting ring is arranged. If the rolling bearing is an axial bearing, the bearing rings are likewise spaced at an axial distance from one another and accommodate the adjusting ring between them. An axial bearing may be embodied as an axial self-aligning roller bearing, an axial ball bearing, an axial tapered roller bearing or as an axial needle bearing, for example.

It may be particularly advantageous in the case of the rolling bearing arrangement according to the disclosure if the bearing rings each have a bearing surface in a mirror-inverted formation relative to the rolling elements. The bearing surface may be of circular segmental or spherical cup-shaped formation, for example, depending on the shape of the rolling elements.

In the case of the rolling bearing arrangement according to the disclosure it may comprise an inner ring on which the rolling elements roll. In this configuration the rolling bearing is embodied as a radial bearing, which comprises the inner ring and two bearing rings in the form of outer rings. Preferably only a single inner ring is provided. The inner ring, at its opposite axial ends, suitably has an enlarged diameter or a board or the like, on which the rolling elements are supported in an axial direction.

In the case of the rolling bearing arrangement according to the disclosure the rolling elements are preferably embodied as balls, rollers, tapered rollers, cylindrical rollers, self-aligning rollers or needle rollers.

Within the scope of the disclosure the two rows of rolling elements may be configured as an X-arrangement or as an O-arrangement. Here the inclination of the longitudinal axes of the rolling elements relative to the axial direction determines whether its is an X-arrangement or an O-arrangement.

### BRIEF DESCRIPTION OF THE DRAWINGS

Further advantages and details of the disclosure are explained below on the basis of exemplary embodiments and with reference to the drawings. The drawings are schematic representations and show:

FIG. 1 shows a detail of an embodiment of a rolling bearing arrangement according to the disclosure in a sectional view;

FIG. 2 shows a partially sectional view of an adjusting ring of the rolling bearing arrangement according to the disclosure shown in FIG. 1; and

FIG. 3 shows a further embodiment of a rolling bearing arrangement according to the disclosure in a sectional view.

### DETAILED DESCRIPTION

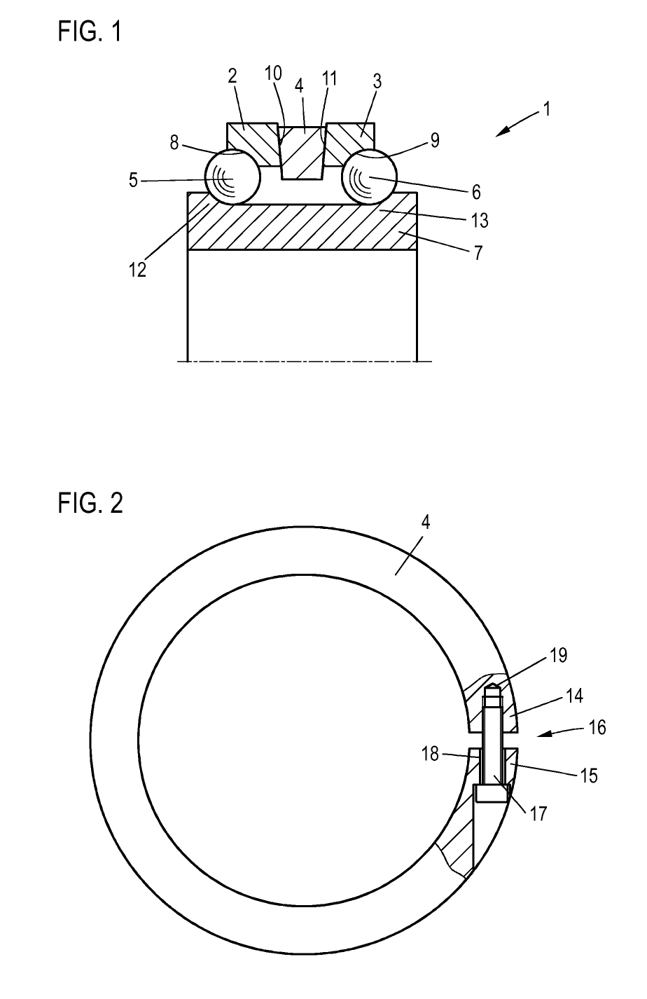

FIG. 1 is a sectional view and shows a rolling bearing arrangement 1, comprising a two-row rolling bearing embodied as a radial bearing having two bearing rings 2, 3 embodied as outer rings spaced at a distance from one another, between which an adjusting ring 4 is arranged, two rows of rolling elements 5, 6 and an inner ring 7. The two symmetrically formed bearing rings 2, 3 have concave bearing surfaces 8, 9, which in the sectional view shown in FIG. 1 extend approximately over one quadrant of a circle. The bearing rings 2, 3 further comprise opposed, slanting surfaces 10, 11, which bear on opposing surfaces of the adjusting ring 4.

On its axial sides 12, 13 the inner ring 7 has bearing surfaces for the rows of rolling elements 5, 6 with an enlarged diameter. It can be seen in FIG. 1 that the rolling elements are embodied as balls. In other embodiments the rolling elements may also be embodied as cylindrical rollers, tapered rollers, needle rollers or self-aligning rollers.

The adjusting ring 4 has a trapezoidal cross section, so that it is arranged as a wedge between the spaced outer rings 2, 3.

The adjusting ring 4 allows adjustment of its diameter. As is shown in the partially sectional view in FIG. 2, the adjusting ring 4 is of split formation. Situated in the area of a gap 16 formed between the ends 14, 15 is a bolt 17, the shank of which passes through an aperture 18 in the end 15 and the thread of which is screwed into a blind hole 19 in the end 14 of the adjusting ring 4. The adjusting ring 4 has a certain elasticity; its diameter can be adjusted by turning the bolt 17. Screwing the bolt 17 into the thread of the blind hole 19 reduces the diameter of the adjusting ring 4; screwing the bolt 17 out increases the diameter. The adjusting ring 4 here acts as an adjustable spring. If the diameter of the adjusting ring 4 is reduced by screwing the bolt 17 in, the adjusting ring 4 moves radially inwards from the position shown in FIG. 1, so that the two outer rings 2, 3 touching the adjusting ring 4 are moved axially apart and the rows of rolling elements 5, 6 press axially against the axial end portions of the inner ring 7 of enlarged diameter. In this way it is possible to reduce or adjust any bearing play that exists.

If the bolt 17 is screwed out on the other hand, the adjusting ring 4 moves radially outwards from the position shown in FIG. 1, so that the bearing rings 2, 3 are not forced apart to such a degree. This reduces a preloading force acting between the bearing rings 2, 3, the rows of rolling elements 5, 6 and the inner ring 7, thereby increasing the bearing play.

The rolling bearing arrangement 1 shown in FIGS. 1 and 2 is an integral part of a wheel-hub drive, in which the bearing play can be easily adjusted by moving the bolt 17.

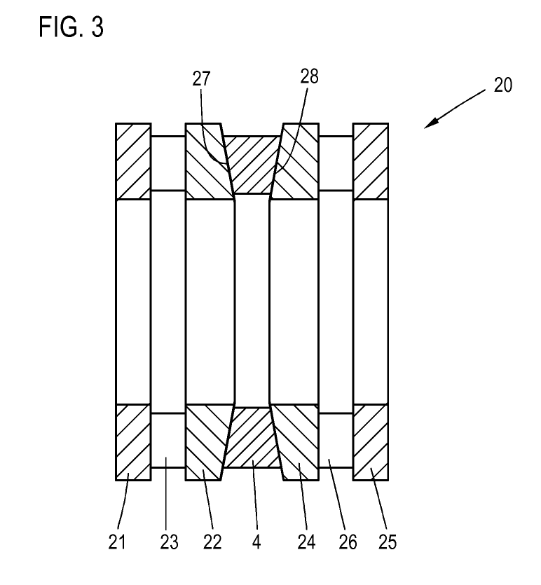

FIG. 3 is a sectional view and shows a further exemplary embodiment of a rolling bearing arrangement 20, which comprises a rolling bearing embodied as an axial bearing. The axial bearing is formed by bearing rings 21, 22, between which a row of rolling elements 23 is situated, and by bearing rings 24, 25, between which a row of rolling elements 26 is situated, and the adjusting ring 4, which is accommodated axially between the bearing rings 22, 24. In the exemplary embodiment shown the rolling elements are embodied as cylindrical rollers.

On its axial sides the adjusting ring 4 comprises wedge surfaces 27, 28, which bear on external surfaces of the bearing rings 22, 24, which each have the same wedge angle. As in the first exemplary embodiment explained with reference to FIGS. 1 and 2, the diameter of the adjusting ring 4 can be adjusted by turning the bolt 17. The adjusting ring 4 thereby moves radially outwards or inwards, so that the bearing rings 22, 24 are displaced axially apart or towards one another. The adjusting ring in the axial bearing shown in FIG. 3 consequently allows easy adjustment of the bearing play.

### LIST OF REFERENCE NUMERALS

1 rolling bearing arrangement
2 bearing ring
3 bearing ring
4 adjusting ring
5 row of rolling elements
6 row of rolling elements
7 inner ring
8 bearing surface
9 bearing surface
10 surface
11 surface
12 axial side
13 axial side
14 end
15 end
16 gap
17 bolt
18 aperture
19 blind hole
20 rolling bearing arrangement
21 bearing ring
22 bearing ring
23 row of rolling elements
24 bearing ring
25 bearing ring
26 row of rolling elements
27 wedge surface
28 wedge surface

1. A rolling bearing arrangement, comprising:
a two-row rolling bearing including rolling elements and two bearing rings; and
an adjusting ring of adjustable diameter and having a variable width in a radial direction arranged between the bearing rings.

2. The rolling bearing arrangement as claimed in claim 1, wherein the adjusting ring is of split design and includes a bolt, that passes through an aperture in one end of the adjusting ring and is screwed into a threaded hole in the other end of the adjusting ring.

3. The rolling bearing arrangement as claimed in claim 1, wherein the adjusting ring has a width diminishing radially inwards.

4. The rolling bearing arrangement as claimed in claim 1, wherein the adjusting ring has a trapezoidal or triangular cross section.

5. The rolling bearing arrangement as claimed in claim 1, wherein the rolling bearing is a radial bearing or an axial bearing.

6. The rolling bearing arrangement as claimed in claim 1, wherein the bearing rings each have a bearing surface in a mirror-inverted formation relative to the rolling elements.

7. The rolling bearing arrangement as claimed in claim 1, wherein the two rolling bearing rows are configured as an X-arrangement or as an O-arrangement.

8. The rolling bearing arrangement as claimed in claim 1, further comprising an inner ring, on which the rolling elements roll.

9. The rolling bearing arrangement as claimed in claim 1, wherein the rolling elements are balls, rollers, tapered rollers, cylindrical rollers, or needle rollers.

10. A rolling bearing arrangement, comprising:
a two-row rolling bearing including two outer bearing rings, an inner ring, and rolling elements, the rolling elements each disposed between one of the two outer bearing rings and the inner bearing ring; and
an adjusting ring of adjustable diameter and having a variable width in a radial direction arranged between the two outer bearing rings, the adjusting ring having a split design and including a bolt configured to pass through an aperture in one end of the adjusting ring and be screwed into a threaded hole in the other end of the adjusting ring;
wherein the adjustable diameter is configured to be adjusted by tightening or loosening the bolt.

11. The rolling bearing arrangement as claimed in claim 10, wherein the adjusting ring has a width diminishing radially inwards.

12. The rolling bearing arrangement as claimed in claim 10, wherein the adjusting ring has a trapezoidal or triangular cross section.

13. The rolling bearing arrangement as claimed in claim 10, wherein the rolling bearing is a radial bearing or an axial bearing.

14. The rolling bearing arrangement as claimed in claim 10, wherein the two outer bearing rings each have a bearing surface in a mirror-inverted formation relative to the rolling elements.

15. The rolling bearing arrangement as claimed in claim 10, wherein the two rolling bearing rows are configured as an X-arrangement or as an O-arrangement.

16. The rolling bearing arrangement as claimed in claim 10, wherein the rolling elements are balls, rollers, tapered rollers, cylindrical rollers, or needle rollers.
